(19) United States
(12) Patent Application Publication
(10) Pub. No.: US 2019/0277433 A1
(43) Pub. Date: Sep. 12, 2019

(54) HOSE COUPLING

(71) Applicant: HOSELINK PTY LTD, Brookvale, New South Wales (AU)

(72) Inventor: Timothy KIERATH, Brookvale (AU)

(21) Appl. No.: 16/335,159

(22) PCT Filed: Sep. 20, 2017
(86) PCT No.: PCT/AU2017/051022

§ 371 Date: Mar. 20, 2019

(30) Foreign Application Priority Data
Sep. 20, 2016 (AU) 2016903787

(51) Int. Cl. F16L 37/252; B29C 45/33

(52) U.S. Cl. CPC F16L 37/252; B29L 2031/24; B29C 45/33

(57) ABSTRACT

A hose coupling (100) having a body member (110) having a proximal end (120) and a distal end (130), a fluid low passage (140) extending along a longitudinal axis (XX) through the body member (110) between the proximal and distal ends (120, 130). The proximal end (120) includes a lug (150) having a first engagement formation (160) and the proximal end (120) includes a keyway (170) having a corresponding second engagement formation (180) in the form of a keyway shoulder (190) projecting generally perpendicular to the longitudinal axis (XX), further wherein the keyway shoulder (190) is integrally formed with the body member (110).

### TECHNICAL FIELD

The present disclosure relates to a hose coupling. In particular, the present invention relates to a hose coupling for use with flexible water hose systems typically used for gardening and residential applications. However, it will be appreciated by those skilled in the art that the hose coupling may be used with other commercial liquid and gas applications.

### BACKGROUND OF THE INVENTION

The present applicant developed a bayonet type hose connector which is described in Australian patent AU 199866040. An example of that prior art hose connector is shown in FIG. 1. Specifically, the hose connector of AU 199866040 has a body member 3 which includes a separate inner coupling 5 which is snap fitted within the body member 3. As can be seen from FIG. 1, the body member 3 includes a lug 14 which extends longitudinally and has a first arcuate projection 15 which extends radially inwardly. Referring to FIG. 1, the projection 15 is designed to be received by a keyway in the form of an arcuate slot 17 which is located between the inner coupling 5 and the inner wall of the body member 3.

The keyway includes a second arcuate projection 19 defined by an undercut formed in the inner coupling 5. The second arcuate projection 19 is directed radially outwardly. As such, the first projection 15 and second projection 19 are adapted to engage each other when the lug 14 is inserted into the keyway and rotated. In this way, each body member 3 has both male and female engagement formations providing a means of coupling like fittings using a twist together and twist apart engagement and disengagement.

An end surface of each inner coupling includes a groove adapted to receive an O-ring. A fluid flow passage extends longitudinally through each inner coupling. The O-ring and the fluid flow passage share a common centre. As such, when two of the body members 3 are arranged face to face and connected by the corresponding lugs 14 and keyways, the two end surfaces are adjacent to each other. The two O-rings are brought into abutment to prevent water leakage, and to enable the transfer of water through the two adjacent fluid flow passages.

The body member 3 and the inner coupling 5 are separately manufactured. The separate manufacturing process is performed to achieve the undercut on the inner coupling 5, beneath the second arcuate projection 19.

After manufacture, the inner coupling 5 is inserted into the body member 3 and twisted into position. Where these two components come together, they do not seal hermetically, but an engagement formation in the form of a tooth and step or other such engagement formation ensures that the inner coupling 5 is effectively permanently secured to the body member 3. This assembly process occurs manually in the factory, prior to the hose coupling being dispatched to consumers, to ensure that they are correctly assembled.

However, the above noted hose coupling suffers from several drawbacks.

Firstly, when a length of hose is to be secured to the connector, an inner hose coupling having a tubular stem is inserted into the open end of the length of hose, and the inner hose coupling is secured to the body member 3 using a nut and washer arrangement. However, if the user has not correctly connected the hose to the hose connector, it is common for water to leak from the end of the hose. The water then travels between the universal body member 3 and the inner coupling 5, and exits through the keyway, and the leaking water then exits from the interface between the two adjacent and engaged body members 3, giving the appearance that it is the O-ring interface that is leaking when in reality this is not the cause of the leakage. This can result in the consumer assuming the hose coupling is faulty, when in fact it is the incorrect installation which causes the leakage.

A further drawback with the above system concerns damage caused by water pressure. Over prolonged periods of time, water pressure can distort the point of connection, rendering the body members unusable. As a way of addressing this problem, the patentee has found it necessary to use a high percentage of fibre fill in the nylon polymer during manufacture. Whilst this increases the longevity of the polymer components, an adverse effect of this is that the tools used during manufacture tend to wear out relatively quickly, which is an undesirable outcome of using high fibre content polymers.

A further disadvantage of the existing hose coupling concerns the size of the hose body member. For example, when two of the body members 3 are engaged end to end along with two hose clamps/collar nuts (which are seated radially around the hose) the total length and size of the junction assembly is reasonably large, which may have visual drawbacks, and have an effect on factors such as spooling of the connected hose.

### OBJECT OF THE INVENTION

It is an object of the present invention to substantially overcome or at least ameliorate one or more of the above disadvantages, or at least to provide a useful alternative.

### SUMMARY OF THE INVENTION

In a first aspect, the present invention provides a hose coupling comprising:

a body member having a proximal end and a distal end, a fluid flow passage extending along a longitudinal axis through the body member between the proximal and distal ends,

wherein the proximal end includes a lug having a first engagement formation and the proximal end includes a keyway having a corresponding second engagement formation in the form of a keyway shoulder projecting generally perpendicular to the longitudinal axis, further wherein the keyway shoulder is integrally formed with the body member.

An aperture is preferably located in a lateral wall of the body member, the aperture being located adjacent to the keyway shoulder.

A single fluid flow passage preferably extends through the body member, further wherein an annular groove is located around the fluid flow passage, the groove being adapted to receive a polymer seal.

The keyway is preferably arcuate and extends about 180 degrees adjacent to a circumferential portion of the body member.

The keyway is preferably recessed into a generally planar surface of the proximal end.

The distal end preferably includes a female threaded aperture adapted to engage with a corresponding hose fitting, further wherein a sealing washer is seated in a base of the threaded aperture.

In a second aspect, the present invention provides a method of manufacturing a hose coupling having a body member having a proximal end and a distal end, the proximal end includes a lug having a first engagement formation and the proximal end includes a keyway having a corresponding second engagement formation in the form of a keyway shoulder, the method comprising the steps of:

injection moulding a polymer using a mould having a first mould portion, a second mould portion and a lateral mould projection which moves in a direction which is generally perpendicular to a direction of separation of the first and second mould portions.

The method further preferably includes the step of withdrawing the lateral mould extension after the polymer has cured to define the keyway shoulder, which is undercut.

### BRIEF DESCRIPTION OF THE DRAWINGS

A preferred embodiment of the invention will now be described by way of specific example with reference to the accompanying drawings, in which:

FIG. 1 shows a prior art hose coupling;

FIG. 2 is a perspective view showing a hose coupling according to the present invention.

FIG. 3 is a side view showing the hose coupling of FIG. 2;

FIG. 4 is an exploded perspective view showing the hose coupling of FIG. 2 depicted with an O-ring, an accessory connector and a washer; and

FIG. 5 is a side cross-sectional view of an assembly including the hose coupling of FIG. 2 for use in terminating an end of a flexible hose.

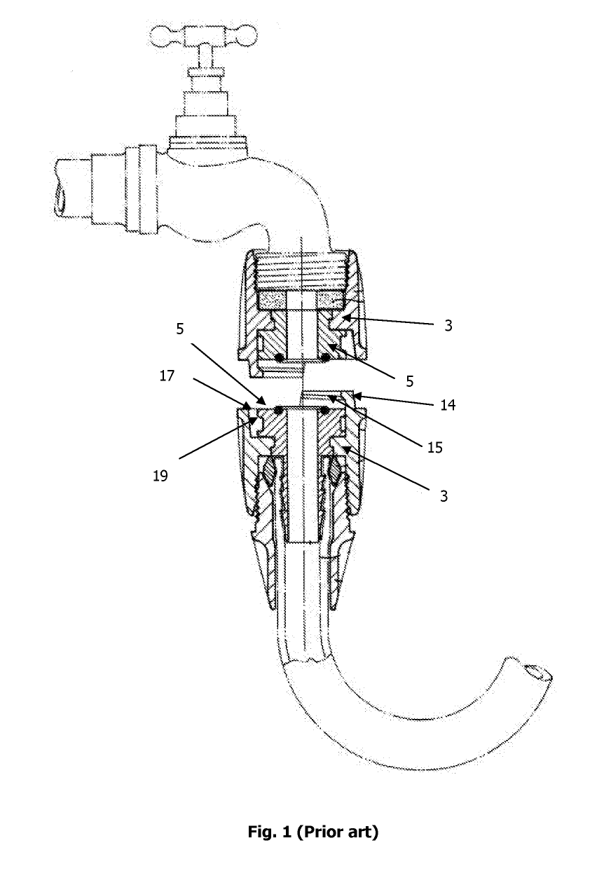

### DETAILED DESCRIPTION OF THE PREFERRED EMBODIMENTS

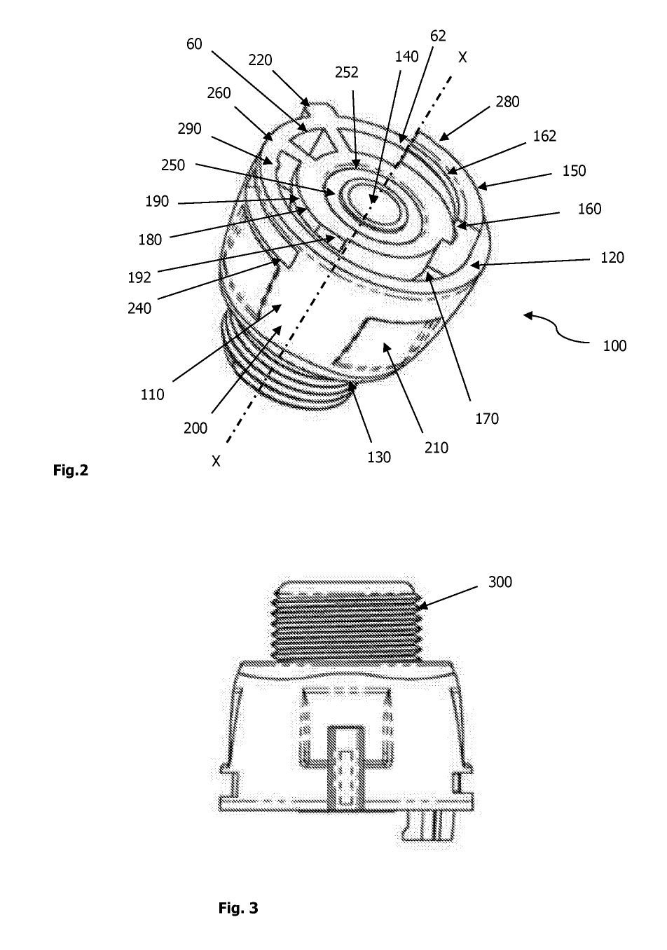

A hose coupling 100 is described herein, and depicted in FIGS. 2 to 5. The hose coupling 100 can be used with other compatible fittings and connectors for several purposes such as connecting a hose to a water outlet tap, connecting two lengths of hose, or connecting a hose to a water usage device, such as a hose fitting or sprinkler.

The hose coupling 100 includes a body member 110 having a proximal end 120 and a distal end 130. A fluid flow passage 140 extends through the body member 110 along a longitudinal axis XX, between the proximal and distal ends 120, 130.

The proximal end 120 includes a lug 150 having a first engagement formation 160. The proximal end 120 also includes a recessed keyway 170 having a corresponding second engagement formation 180 in the form of a keyway projection or shoulder 190. The keyway shoulder 190 projects generally perpendicular to the longitudinal axis XX. The keyway shoulder 190 is integrally formed with the body member 110, as will be described in more detail below.

The keyway 170 is arcuate and extends approximately 180 degrees adjacent to a circumferential portion of the body member 110.

The lug 150 is also arcuate and extends approximately 90 degrees relative to the circumferential portion of the proximal end 120 of the body member 110. The first engagement formation 160 is defined by an arcuate step 162 which extends radially inwardly from the lug 150, and generally perpendicular to the longitudinal axis XX. The thickness of the step 162 (in a direction extending parallel to the longitudinal axis) increases gradually across the width of the step 162.

As shown in FIG. 2, the lug 150 is located on the same radius as the keyway 170, and the lug 150 commences approximately where the keyway 170 terminates. Referring to FIG. 2, the keyway 170 includes a transitional surface 192 where the keyway shoulder 190 commences 190, and the width of the keyway 170 decreases. This enables the first engagement formation in the form of the arcuate step 162 to engage with the keyway shoulder 190.

An outer surface 200 of the body member 110 includes a plurality of depressions 210 spaced around the outer surface 200. The depressions 210 assist a user to grip the body member 110 during coupling or decoupling of the hose coupling 100.

An alignment tab 220 is located around the circumference of the body member 110. The alignment tab 220 assists a user to visually determine if the coupling 100 is in a completely secured configuration, as the alignment tabs 220 of two connected body members 110 are in radial alignment when the two hose couplings 100 are correctly secured.

An aperture or cut-out 240 is located in the outer surface 200 of the body member and the aperture 240 is located adjacent to the keyway shoulder 190. The aperture 240 enables the undercut of the keyway shoulder 190 to be formed simultaneously with the remainder of the hose coupling 100 in a single injection moulding process.

The proximal end 120 of the hose coupling 100 includes a generally planar surface 260, wherein the keyway 170 is recessed into the planar surface 260, and the lug 150 projects above the planar surface 260.

Importantly the hose coupling 100 has a single fluid flow passage 140 which extends through the body member 110 and an annular groove 250 is located around the fluid flow passage 140. The groove 250 is adapted to receive a polymeric seal in the form of an O-ring 252, which extends slightly above the planar surface 260.

A notch or channel 280 is formed in the radially outer surface of the lug 150. The channel 280 extends parallel with the longitudinal axis XX. The channel 280 is adapted to engage with a corresponding rib 290 formed on a radially outer surface of the keyway 170. The rib 290 also extends parallel with the longitudinal axis XX.

In the embodiment depicted in the drawings, the hose coupling 100 includes at the distal end 130 a female threaded aperture 300 which is adapted to engage with a corresponding hose fitting, such as a tap outlet (not shown). In this embodiment, a sealing washer 320 is seated in a base of the threaded aperture.

In the embodiment depicted in FIGS. 2 to 4, an accessory connector 300 and washer 310 are shown which are used with the hose coupling 100. The accessory connector 300 has two male threaded ends, and is used for example when the hose coupling 100 is connected to a hose nozzle or sprinkler.

However, it will be appreciated that in other embodiments, the distal end 130 of the hose coupling 100 may be provided terminating with other connection means such as an integrally formed male threaded portion.

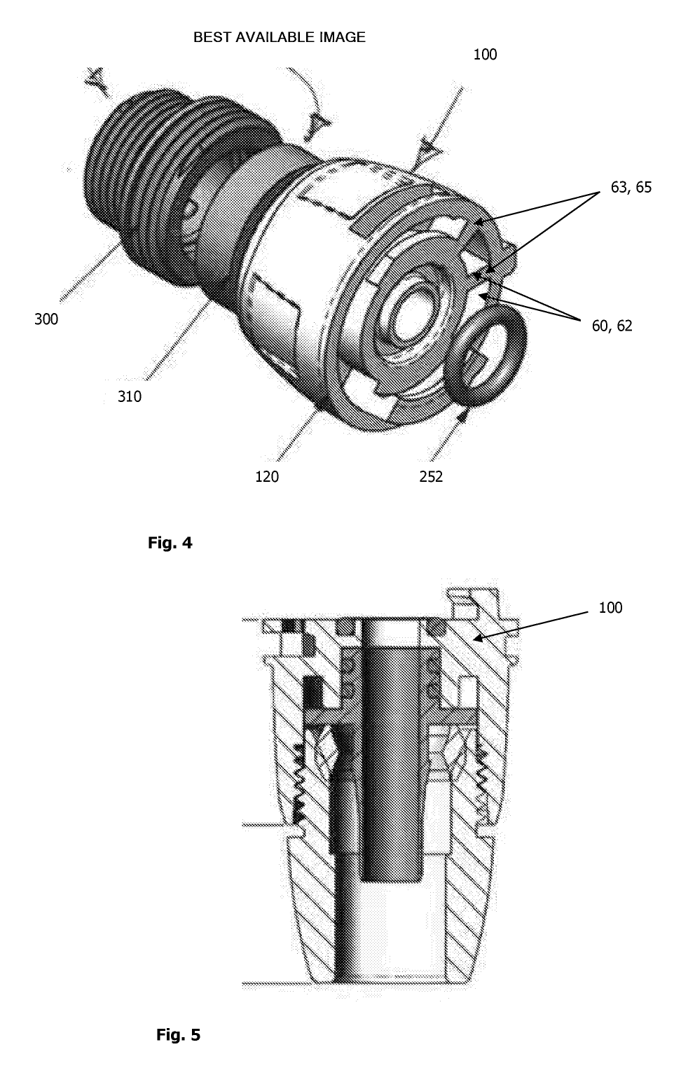

As shown in FIGS. 2 and 4, two recesses 60, 62 are formed in the proximal end 120 of the body member 110. The recesses 60, 62 provide a reduction in wall thickness of the body member 110. In addition, the two radially extending bridges 63, 65 which partially define the recesses 60, 62 provide increased structural rigidity, minimising the risk of distortion when the hose coupling 100 is subjected to high internal water pressures.

The manufacture of the hose coupling 100 is performed using an injection moulding process. It is generally difficult to produce undercuts such as the keyway shoulder 190 using injection moulding processes, as it is difficult to extract the mould after the polymer is set. However, in order to overcome this problem, the aperture or cut-out 240 located in the outer surface 200 permits a lateral portion of the mould to be withdrawn, generally in a direction which is perpendicular to the axis XX after completion of the polymer curing during the injection moulding process.

Specifically the method of manufacturing the hose coupling 100 includes injection moulding a polymer using a mould having a first mould portion, a second mould portion and a lateral mould projection which moves in a direction which is generally perpendicular to a direction of separation of the first and second mould portions. The withdrawal of the lateral mould portion defines the keyway shoulder 190, which is in the form of an undercut.

This enables the moulding process to be completed in a single stage, and negates the need for multiple moulding stages or assembling processes. This also negates the need to provide a separate inner coupling as shown in the cited prior art.

Advantageously, the hose coupling 100 is manufactured in a single piece, thereby simplifying and reducing the cost of the manufacture and assembly processes.

Advantageously, the hose coupling 100 permits moulding to occur in a single process, negating the need to manufacture separate inner and outer components.

Advantageously the hose coupling 100 provides increased structural strength.

A further advantage of the hose coupling 100 is that a lower percentage of fibre fill is required during the injection moulding process, meaning longer lasting tools.

Although the invention has been described with reference to specific examples, it will be appreciated by those skilled in the art that the invention may be embodied in many other forms.

1. A hose coupling comprising:
a body member having a proximal end and a distal end, a fluid flow passage extending along a longitudinal axis through the body member between the proximal and distal ends,
wherein the proximal end includes a lug having a first engagement formation and the proximal end includes a keyway having a corresponding second engagement formation in the form of a keyway shoulder projecting generally perpendicular to the longitudinal axis, further wherein the keyway shoulder is integrally formed with the body member.

2. The hose coupling of claim 1, wherein an aperture is located in a lateral wall of the body member, the aperture being located adjacent to the keyway shoulder.

3. The hose coupling of any one of the preceding claims, wherein a single fluid flow passage extends through the body member, further wherein an annular groove is located around the fluid flow passage, the groove being adapted to receive a polymer seal.

4. The hose coupling of any one of the preceding claims, wherein the keyway is arcuate and extends about 180 degrees adjacent to a circumferential portion of the body member.

5. The hose coupling of claim 4, wherein the keyway is recessed into a generally planar surface of the proximal end.

6. The hose coupling according to any one of the preceding claims, wherein the distal end includes a female threaded aperture adapted to engage with a corresponding hose fitting, further wherein a sealing washer is seated in a base of the threaded aperture.

7. A method of manufacturing a hose coupling having a body member having a proximal end and a distal end, the proximal end includes a lug having a first engagement formation and the proximal end includes a keyway having a corresponding second engagement formation in the form of a keyway shoulder, the method comprising the steps of:
injection moulding a polymer using a mould having a first mould portion, a second mould portion and a lateral mould projection which moves in a direction which is generally perpendicular to a direction of separation of the first and second mould portions.

8. The method of claim 7, including the step of withdrawing the lateral mould extension after the polymer has cured to define the keyway shoulder, which is undercut.
